(19) United States
(12) Patent Application Publication
(10) Pub. No.: US 2013/0329048 A1
(43) Pub. Date: Dec. 12, 2013

(54) MULTI-FUNCTION SAFETY HAMLET

(71) Applicant: YAN CIH WANG, Taoyuan (TW)

(72) Inventor: YAN CIH WANG, Taoyuan (TW)

(21) Appl. No.: 13/494,031

(22) Filed: Jun. 12, 2012

(51) Int. Cl. H04N 7/18

(52) U.S. Cl. 348/158; 348/E07.085

(57) ABSTRACT

A multi-function safety hamlet includes a hamlet body having a lining for covering wearer's head and a camera for recording video. The camera is arranged to the hamlet body facing ahead so as to record the sight in front of the user.

### FIELD OF THE INVENTION

The present invention relates to hamlets, and particular to a multi-function safety hamlet having a camera, safety alarm, music player, and hands-free speaker.

### DESCRIPTION OF THE PRIOR ART

Hamlet is a basic and the most important safety equipment for protecting a bicycle or motorcycle rider. Prior hamlet provides only the protection of rider's head and neck. However, a safety device is arranged to the hamlet to alert the following vehicle for safety.

For example, a flashing light arranged to a rear of the hamlet can provide an obvious sign for other vehicle at night or in a raining day. There are also direction and brake lights arranged on the rear of the hamlet to enhance the safety of riding. Such device can provide passive safety to the rider, but the rider still need further protection during an accident except the cameras arranged randomly on the streets.

### SUMMARY OF THE PRESENT INVENTION

Accordingly, the primary object of the present invention is to provide a multi-function safety hamlet having functions of recording video, safety alarm, music playing, and hands-free speaker. The video recorded by the multi-function safety hamlet is nearly equivalent to the eye sight of the rider so that the video can be used for a proof during an accident. The video can also be regarded as an evidence for any illegality committed around. A buzzer is used to alert the surrounding for any trouble or uncomfortableness happened to the vehicle or the rider. The hamlet can be also used as a safety hamlet in a factory or construction site for recording the operation of the worker in case of any safety issue happened.

### BRIEF DESCRIPTION OF THE DRAWINGS

FIG. 1 is a perspective view showing a preferable embodiment of the present invention.

FIG. 2 is another perspective view showing the preferable embodiment of the present invention.

FIG. 3 is an upward view showing the preferable embodiment of the present invention.

FIG. 4 is a system diagram of the referable embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

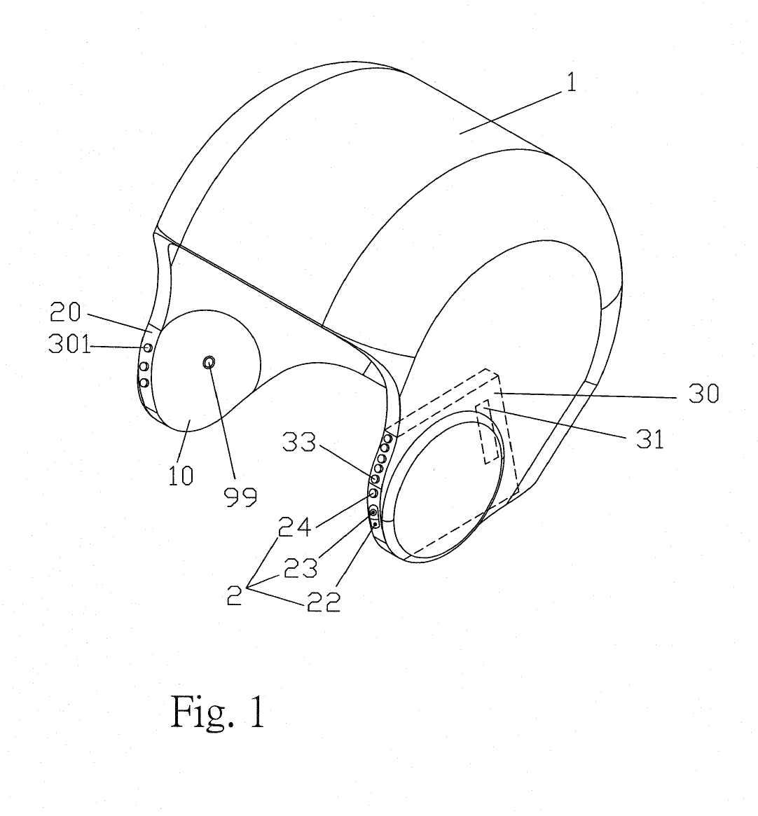

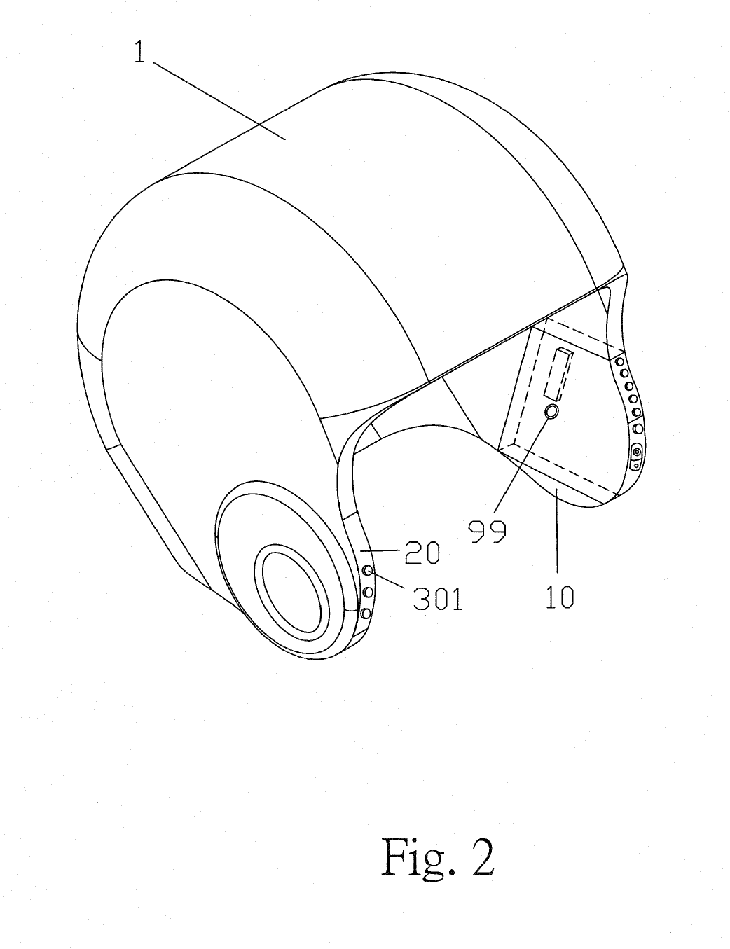

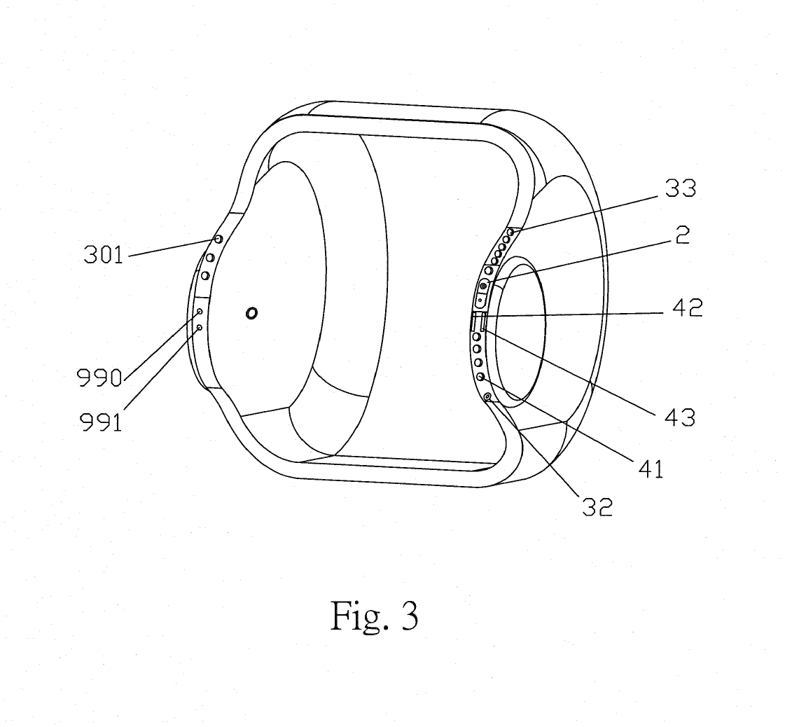

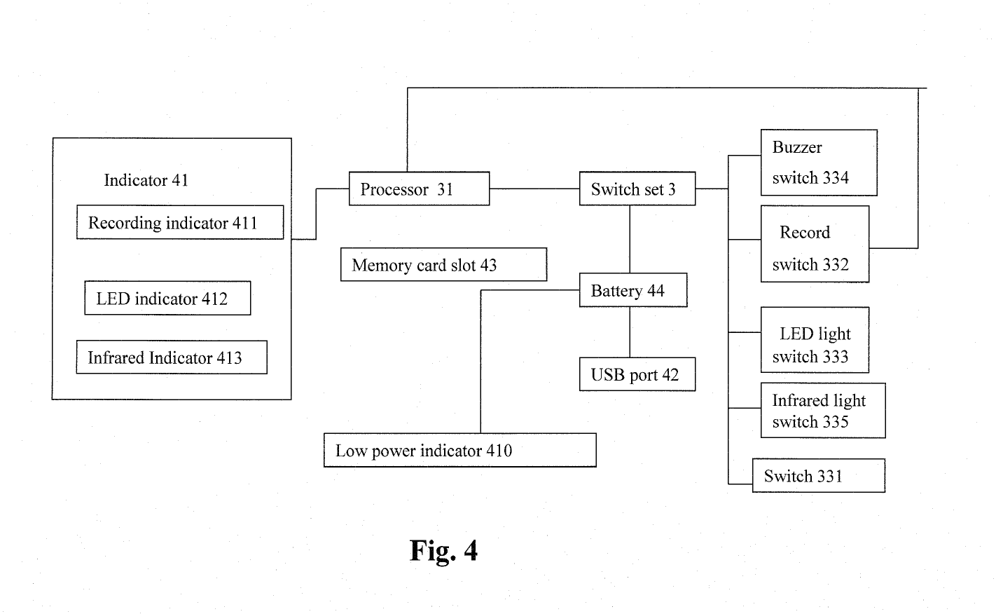

Referring to FIGS. 1 to 4, a preferable embodiment of a multi-function safety hamlet according to the present invention is illustrated. The multi-function safety hamlet includes the following components.

A hamlet body 1 has a lining 10, the lining 10 can cover the wearer's head for safety.

A left box 20 arranged to a lower left side of the hamlet body 1. The left box 20 includes a processor 21, camera set 2, switch set 3, and an indicator set 4. The processor 21 serves to integrate and control the components inside the left box 20 and external devices, the processor also process the signal of the components and the devices.

The camera set 2 serves to record the sight in front of the wearer, the video recorded is transmitted to the processor 21. The camera set 2 arranged to a lateral side of the left box 20 includes an infrared light 22, lens 23, and LED light 24. The infrared light 22 serves to aim the object to be shot by the camera set 2 (as the aiming device arranged to a rifle). The lens 23 can record the sight in front of the hamlet. The LED light 24 is an assistance of illumination for camera set 2 and also can be used as a flash light.

The switch set 3 having a buzzer 32 and a plurality of switch 33 is arranged to the left box 20. The processor 21 is electrically connected to the plurality of switch 33 so as to enable corresponding component by pressing the relative switch 33. The buzzer 32 can buzz for alarm. The plurality of switch 33 includes a power switch 331, record switch 332, LED light switch 33, buzzer switch 334, and an infrared light switch 335. The switches 33 are both water-proof thin switches.

The indicator set 4 is electrically connected to the processor 21 for lighting up by the command from the processor 21. The indicator set 4 includes a low power indicator 410, recording indicator 411, LED indicator 412, and an infrared light indicator 413. The low power indicator 410 will light up while the battery is low for reminding the need of recharge. The recording indicator will light up while the recording of camera set 2 is enabled. The LED indicator 412 will light up while the LED light 24 is turned on. The infrared light indicator 413 will light up while the infrared light 22 is turned on. Above indicators are integrated to the corresponding water-proof switches 33 for indication. For example, the low power indicator 413 is embedded in the power switch 331; the recording indicator 411 is embedded in the record switch 332.

The left box 20 further includes a USB port 42 for being connected by electronic product or charging.

A memory card slot 43 for receiving a memory storage device, the video recorded by the lens 23 can be saved to the memory card through the processor 21.

The left box 20 has a rechargeable battery for supplying power to the components.

A WiFi-SOS device 44 is arranged inside the left box 20 for automatically searching wireless router through wireless technique. Once a network is successfully connected, the video stored in the memory card will be uploaded to a specific network space such as a cloud server or a social network. The video being uploaded will be deleted in the local memory card so that the video will not be overwrote due to lack of memory space.

The hamlet body 1 further includes a right box 30 arranged to a lower right side thereof. The right box 30 includes a media controller 301 capable of controlling volume, track selection, and phone answering.

A speaker 99 arranged to the left box 20 and the right box 30 respectively.

An earphone plug 990 is arranged to a bottom of the right box 30 for connecting cell phones for broadcasting the sound of the cell phone through the speaker. The earphone plug 990 is compatible with standard 3.5 mm earphone plug.

A microphone 991 is arranged to the hamlet body 1 to receive wearer's voice for hands-free speaking on the phone.

A MP3 player is arranged inside the right box 30 to play audio media through the speaker. When the cell phone connected to the earphone plug 990 receives a phone call, the phone call will be broadcasted by the speaker so that the user can answer the phone by pressing the media controller. After the phone call is finished, the speaker will continuously broadcast audio media from the MP3 player. The MP3 player has a mini SD port 992 supporting 32 Gigabyte SD card and various audio formats. The MP3 player has its own battery for power supply. A mini USB port 993 is arranged to the hamlet body 1 for recharging the MP3 player and file transferring.

The left box and the right box of the present invention are both water-proof. All the port for external connection has water-proof cover, the cover can be opened for connection.

The video recorded by the multi-function safety hamlet is nearly equivalent to the eye sight of the rider so that the video can be used as a proof during an accident. The video can also be regarded as an evidence for any illegality committed around. The buzzer can be used to alert the surrounding for any trouble or uncomfortableness happened to the vehicle or the rider. The hamlet can be also used as a safety hamlet in a factory or construction site for recording the operation of the worker in case of any safety issue happened.

Through the above description, the present invention has the following advantages.

1. The video recording function of the present invention can preserve video evidence for personal safety against any illegality happened around.

2. With the high fidelity sound recording, audio evidence can be preserved with the recorded video at the same time.

3. The field of view of the camera can be adjusted with the assistance of visible infrared light.

4. The LED light can provide high brightness illumination.

5. The buzzer can alarm for help during an accident or to frighten a criminal. The alarm of the buzzer must be stopped under a predetermined sequence or code.

6. The MP3 player can provide music to ease the user for long time travel.

7. The standard 3.5 mm earphone plug can support most of cell phone for music playing and phone answering so as to ensure the safety and convenience.

8. The WiFi-SOS device can transmit data to cloud server through wireless technique so that memory space will not full and the video record will not be overwrote.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multi-function safety hamlet having function of video recording, safety alarm, music player, and hands-free speaker comprising:
a hamlet body having a lining to cover user's head for safety; and
a camera set having a lens for recording video; the lens being arranged to the hamlet body facing ahead.

2. The multi-function safety hamlet as claimed in claim 1 further comprising a record switch to enable the recording of the camera set and a recording indicator for showing the recording status.

3. The multi-function safety hamlet as claimed in claim 1 further comprising a battery and a power switch.

4. The multi-function safety hamlet as claimed in claim 3 further comprising a low power indicator for reminding the need of recharge once the battery is low.

5. The multi-function safety hamlet as claimed in claim 1, wherein the camera set has an adjustment gear for tuning focus and angle of the lens.

6. The multi-function safety hamlet as claimed in claim 1 further comprising a LED light with a light switch for getting clearer image during video recording.

7. The multi-function safety hamlet as claimed in claim 6 further comprising a LED status indicator which will on with the LED light for indication.

8. The multi-function safety hamlet as claimed in claim 1 further comprising an infrared light with an infrared light switch and an infrared light indicator; the infrared light pointing at the direction of the camera; the infrared light indicator being on with the infrared light for indication.

9. The multi-function safety hamlet as claimed in claim 1 further comprising a processor, wherein the processor serves to integrate and control the components of the multi-function safety hamlet.

10. The multi-function safety hamlet as claimed in claim 1 further comprising a buzzer with a buzzer switch for providing alarm sound.

11. The multi-function safety hamlet as claimed in claim 1 further comprising a USB recharge port for recharging.

12. The multi-function safety hamlet as claimed in claim 1 further comprising a memory card slot for receiving a memory card to store the video.

13. The multi-function safety hamlet as claimed in claim 1 further comprising a speaker arranged to the right and left side of the hamlet body respectively.

14. The multi-function safety hamlet as claimed in claim 13 further comprising a media controller for controlling volume and sound track selection.

15. The multi-function safety hamlet as claimed in claim 13 further comprising an earphone plug for connecting a cell phone for broadcasting the sound of the cell phone through the speaker so that the multi-function safety hamlet can provide a hands-free phone answering function.

16. The multi-function safety hamlet as claimed in claim 13 further comprising a microphone arranged to the hamlet body to receive user's voice for hands-free phone answering.

17. The multi-function safety hamlet as claimed in claim 14, wherein the media controller serves to answer a phone call.

18. The multi-function safety hamlet as claimed in claim 1, wherein a WiFi-SOS device is arranged for automatically searching wireless router through wireless protocol; once a network is successfully connected, the recorded video will be uploaded to a specific network space.

19. The multi-function safety hamlet as claimed in claim 18, wherein the video being uploaded will be deleted in the local memory card.
